(19) United States
(12) Patent Application Publication
(10) Pub. No.: US 2026/0226332 A1
(43) Pub. Date: Aug. 6, 2026

(54) COMPOSITION COMPRISING RESIN FROM CANARIUM OVATUM TREE AND METHOD OF MAKING THEREOF FOR SEALANTS AND FLAME RETARDANTS

(71) Applicant: Mark Kennedy BANTUGON, Batangas (PH)

(72) Inventor: Mark Kennedy BANTUGON, Batangas (PH)

(21) Appl. No.: 18/699,284

(22) PCT Filed: Dec. 10, 2021
(86) PCT No.: PCT/PH2021/050042

§ 371 Date: Apr. 7, 2024

(30) Foreign Application Priority Data
Oct. 6, 2021 (PH) 12021050500

(51) Int. Cl. C09J 193/00; C09F 1/00; C09J 9/00

(52) U.S. Cl. CPC C09J 193/00; C09F 1/00; C09J 9/00

(57) ABSTRACT

The present invention pertains to compositions comprising resin from Canarium ovatum tree. Said compositions may be used to prepare sealants, base materials for sealants, and flame retardants. Thus, such compositions find application, in particular, in sealing fuel tanks and those integrated into the structure of aircraft. The method of making the composition for a sealant involves the step of mixing resin from Canarium ovatum tree with a suitable solvent to produce a base material, followed by the step of mixing this base material with an activator.

### TECHNICAL FIELD OF INVENTION

The present invention relates to sealants and flame retardant compositions, methods of preparation thereof, and, in particular, their applications to aircraft fuel tanks.

### BACKGROUND OF THE INVENTION

There is a rising demand for aerospace adhesive and sealants for commercial, military, and general aviation sectors, the commercial sector being the largest group among these.

One of the most common sealing materials used in the commercial end-user industry is polysulfide-based sealant. It is the first aerospace sealant and has been in use in the aircraft industry for over 50 years. It is resistant to aviation fuels and, therefore, helpful in sealing fuel tanks. Some of the advantages of polysulfide-based sealants are excellent adhesion to aluminum, titanium, other metals and composites, low permeation to fuel vapor, water vapor, and air, good low-temperature flexibility, good heat resistance, good elasticity, reasonable strength (in the presence of fuels), good resilience, good adhesion of the new sealant to old sealant (i.e., in repair), and ease in application.

Naftoseal® MC-238 of the Chemetall Company is an example of polysulfide-based sealants. Comprising 75% concentration of polysulfide polymer serving as its base ingredient, this type of sealant has the highest amount of polysulfide-polymer among its class of sealants.

Listed below are the complete composition of Naftoseal® MC-238, including its base and hardener material, with its Concentration Percentage/Percentage Composition through tabular form.

TABLE 1
Complete composition of Naftoseal ® MC-238

| | |
|---|---|
| | Concentration (%)/ |
| Chemical Name | Percentage Composition |

For Base Material:

| | | |
|---|---|---|
| Polysulfide Polymer | Polysulfide polymer; | >=25-<50 |
| | Molecular | |
| | weight >1800 | |
| | Polysulfide polymer; | >=10-<25 |
| | Molecular | |
| | weight <1800 | |

| | |
|---|---|
| Ethyl acetate | >=3-<10 |

For Hardener Material:

| | |
|---|---|
| Manganese dioxide | >=25-<50 |
| Amino-thiocarbonylsulfide | >=2.5-<10 |
| Ethoxylated Nonylphenolphosphate | >=0.25-<1 |
| Sodium Hydroxide | >=0.5-<1 |
| Phthalic anhydride | >=0.1-<1 |

Among the drawbacks of polysulfide-based sealants is water and antifreeze absorption, which leads to swelling and a drop in effectiveness and properties, particularly tear-resistance and adhesion. In addition, these polysulfide-based sealants are described under Section 3 (Composition/Information on Ingredients) of its Material Safety Data Sheet (MSDS) as cause of severe eye, respiratory, and skin irritation; and long-term adverse effects to aquatic animals; and as flammable liquid and vapours. They also cause damage to organs and even genetic defects or cancer through prolonged or repeated exposure by inhalation or ingestion. Health hazards associated with polysulfide-based sealants pose a problem for aircraft manufacturers, operators, and maintenance crews.

There is a heightened need for a sealant with at least the same effectiveness as polysulfide-based sealants but with minimized health and environmental hazards.

A prior art reference with U.S. patent Ser. No. 10/428,261 B2 ('261) titled “Resin Composite with Overloaded Solids for Well Sealing Applications” teaches a sealing material comprising one or more solid particulates intermixed in the fluid material to form the sealing material wherein the one or more solid particulates are about 22% to about 30% by volume fraction of the sealing material upon being intermixed in the fluid material; wherein at a location to be sealed, the sealing material includes: a first portion having a first concentration of the one or more solid particulates; a second portion having a second concentration of the one or more solid particulates, and wherein the second concentration is less than the first concentration; and further comprising of at least one of magnesium oxide, sand, silicon carbide, and graphite. However, '261 fails to teach a sealant with a composition consisting of resin from Canarium ovatum tree and its method of making thereof.

### OBJECTIVE OF THE INVENTION

It is the object of the present invention to provide a composition for a sealant for use in the aircraft industry, in particular a sealant for fuel tanks, which possesses the requisite properties for its function and at the same time poses minimal health and environmental hazards. It is a further objective of this invention to provide a method for making said sealant.

### SUMMARY OF THE INVENTION

The present invention aims to overcome the drawbacks of polysulfide-based sealants while providing the properties required of aerospace sealants. Hence, the present invention provides a composition for the base material for a sealant in which resin from Canarium ovatum, also known as pili tree is used instead of the synthetic polysulfide polymer. The invention accordingly comprises combinations of said resin with solvents and activator agents to provide the required mechanical, thermal, and rheological properties of an aerospace sealant for use in fuel tanks while minimizing chemical components that pose health and environmental hazards. The invention also provides a method for making said combinations.

### DETAILED DESCRIPTION OF THE INVENTION

The composition for a sealant of the present invention is prepared, firstly, by making a binder composition or mixture. This is done by mixing resin collected from the Canarium ovatum tree with a suitable solvent. One example of such solvent is toluene.

The resin can be either in its raw form or spent form, also known as undried or dried resins respectively. The drying of the raw resin is accomplished through the hydrodistillation process which separates the essential oils from the dried resin. Both dried and undried resins are suitable for formulating a flame-retardant sealant, as discussed further.

The ratio of the resin to solvent may be varied. Mixing is complete when the binder composition appears homogeneous. To prepare the sealant itself, the binder composition is then mixed with a suitable hardener, also known as activator or activation agent. Manganese dioxide is used as an activator to prepare and test the sealant of the present invention. In practice, however, any suitable solvent for the resin and any suitable hardener or activator may be used. The example here should not be construed as limiting the choices in solvent and activator.

The detailed method of making the sealant using raw Canarium ovatum resin is elaborated in the following section.

Extracting raw Canarium ovatum tree resin is done by removing loose barks, dirt, and other foreign matter and lightly scraping the portion to be tapped. The first tapping occurs at a point not more than 60 cm from the ground due to the Canarium species being known for its high buttresses.

A horizontal cut of about 2 cm wide and 15 cm long using a knife is done with care to avoid damaging the cambium. A space of twice the width of the tapping must be maintained. Subsequent chippings of about 3 mm to 5 mm wide should proceed vertically straight. The initial tapping cut should be 15 cm wide along the circumference and 1 to 2 cm wide along the height of the tree.

A wooden mallet may be used to hammer the knife and control the depth of the cut. Other cuts may be made of the same dimension as the first cut at 15 cm but the distance between the tapped portions must be about 30 cm or twice the length of the cut.

As the resin exuded by the tree hardens slowly, a plastic receptacle should be tacked below the cut. The tapped trunk should be covered with a polyethylene sheet and sealed with plastic roofing cement. This will prevent the entry of moisture, insects, and other debris such as dried leaves, bark, and dust into the cuts.

Post extraction of the raw resin from the Canarium ovatum tree from its bark, toluene is mixed, and the resulting mixture is the base material of the experimental sealant. Manganese dioxide is subsequently prepared in a separate container and will serve as hardener.

The formulation process includes completely mixing the base material with the hardener material and subsequently curing before its application and testing.

The detailed method of making the sealant using dried Canarium ovatum resin is as follows.

After the extraction of the resin from the Canarium ovatum tree bark, it may be subjected to hydrodistillation process. This process involves the separation of essential oils and spent or de-oiled resin since Canarium ovatum tree resin is an oleoresin.

The spent/de-oiled resin, now dried resin, is ground and is the base ingredient for the flame-retardant sealant formulation. With the drying process, the powderized resin can be easily dissolved by the solvent.

The toluene is subsequently mixed with the dried resin and will then serve as the base material for the flame-retardant sealant. Manganese dioxide is then prepared in a separate container and will serve as a hardener.

The formulation process of the sealant involves completely mixing the base material with the hardener and subsequent curing before application and testing.

In validating the effectiveness and applicability of the formulated sealants, five properties namely physical, chemical, mechanical, thermal, and rheological properties are used to analyze and determine material properties by conducting different standard testing. In terms of physical properties, Organoleptic Test (Color, Odor, and Appearance Test), Instrumental Color Measurement Test, and Flash Point Test are used. Chemical properties such as Tack-Free Time Test, Curing Time Test, Toxicity Test, and Shore-A Hardness Test are also executed. Additionally, for the mechanical properties of the sealant, Shear Strength Test, Tensile Strength, Tear Strength Test, Peel Strength Test, Knife Test, Pull-off Test are also of particular importance.

On the other hand, Thermogravimetry-Differential Thermal Analysis, Differential Scanning Calorimetry and Calorific Value refer to the thermal properties of the formulated sealant. The rheological property of the sealant is quantified through Viscosity Test.

The various results from material characterization are discussed in the following section.

### Example 1: Consistency of Binder Formulations for the Sealant

Twenty-two compositions of binders were preliminarily inspected to quantify the homogeneity of the resulting mixture with for both precursors of dried and undried nature. The various pili tree resin weights are mixed with toluene. This initial test is used to quantify if the Canarium ovatum tree resin has acceptable homogeneity characteristics when mixed with an organic solvent such as toluene.

TABLE 2
Homogeneity testing for various binder compositions

| | | Composition | | | |
|---|---|---|---|---|---|
| | | Pili tree | Toluene | | |
| | | resin | (p = 0.87 g/ml) | | Consistency |
| Composition | Description | (in grams) | in g | in ml | of Mixture |
| A | (undried) | 14 | 6 | 6.90 | Homogenous |
| B | (undried) | 14.50 | 5.50 | 6.32 | Homogenous |
| C | (undried) | 15 | 5 | 5.75 | Homogenous |
| D | (undried) | 15.50 | 4.50 | 5.17 | Homogenous |
| E | (undried) | 16 | 4 | 4.60 | Homogenous |
| F | (undried) | 16.50 | 3.50 | 4.02 | Homogenous |
| G | (undried) | 17 | 3 | 3.45 | Homogenous |
| H | (undried) | 17.50 | 2.50 | 2.87 | Homogenous |
| I | (undried) | 18 | 2 | 2.30 | Homogenous |
| J | (undried) | 18.50 | 1.50 | 1.72 | Homogenous |
| K | (undried) | 74 | 14 | 16.09 | Homogenous |
| L | (undried) | 14 | 6 | 6.90 | Homogenous |
| M | (dried) | 14.50 | 5.50 | 6.32 | Homogenous |
| N | (dried) | 15 | 5 | 5.75 | Homogenous |
| O | (dried) | 15.50 | 4.50 | 5.17 | Homogenous |
| P | (dried) | 16 | 4 | 4.60 | Homogenous |
| Q | (dried) | 16.50 | 3.50 | 4.02 | Homogenous |
| R | (dried) | 17 | 3 | 3.45 | Homogenous |
| S | (dried) | 17.50 | 2.50 | 2.87 | Homogenous |
| T | (dried) | 18 | 2 | 2.30 | Homogenous |
| U | (dried) | 18.50 | 1.50 | 1.72 | Homogenous |
| V | (dried) | 74 | 14 | 16.09 | Homogenous |

It can be observed that all binder compositions for both dried and undried Canarium ovatum tree resin showed acceptable homogeneity and may be subsequently mixed with an activator to comprise a sealant.

### Example 2: Flammability Test of Sample Formulations of the [Flame Retardant Composition/Sealant]

Twelve different sealant formulations exhibited satisfying and suitable mixture consistency of base and hardener material were subjected to Flammability Test, an important test and consideration according to air laws and regulations specifically the 14 Code of Federal Regulation Appendix N to Part 25—Fuel Tank Flammability Exposure and Reliability Analysis to get the best formulation of experimental sealant. A commercial sealant is also tested on the same parameters and conditions similar to the twelve sealant formulations.

Based on the results, four (4) sealant formulations, particularly the 18 g, 18.50 g and 74 g of undried Canarium ovatum resin and 17.50 g of dried Canarium ovatum resin, passed the standard test showing the resistance of those experimental sealant formulations to flame. Further, no ignition and flame occurred in the four mentioned sealant formulations during the whole duration of the test. On the other hand, the remaining eight sealant formulations fail to withstand the flammability conditions, which caused the occurrence of flame and ignition. However, after this ignition, the eight sealant formulations can self-extinguished condition where the flame stops burning.

TABLE 3
Flammability test of different formulations of experimental sealant against the control
COMPOSITION

| | | Pili Tree | | | Manganese | | |
|---|---|---|---|---|---|---|---|
| | | Resin | Toluene | | Dioxide | Flammability | Time |
| Composition | Description | (in grams) | (in grams) | (in mL) | (in grams) | Result | (in sec.) |
| 1 | 16 grams | 16 | 4 | 4.60 | 2 | Self-extinguished | 3.50 |
| | (undried) | | | | | | |
| 2 | 16.50 grams | 16.50 | 3.50 | 4.02 | 2 | Self-extinguished | 3.50 |
| | (undried) | | | | | | |
| 3 | 17 grams | 17 | 3 | 3.45 | 2 | Self-extinguished | 2 |
| | (undried) | | | | | | |
| 4 | 17.5 grams | 17.50 | 2.50 | 2.87 | 2 | Self-extinguished | 2 |
| | (undried) | | | | | | |
| 5 | 18 grams | 18 | 2 | 2.30 | 2 | Did not ignite | 0 |
| | (undried) | | | | | | |
| 6 | 18.5 grams | 18.50 | 1.50 | 1.72 | 2 | Did not ignite | 0 |
| | (undried) | | | | | | |
| 7 | Naftoseal ® MC-238 (commercial sealant) | | | | | Did not ignite | 0 |
| 8 | 16 grams | 16 | 4 | 4.60 | 2 | Self-extinguished | 2 |
| | (dried) | | | | | | |
| 9 | 16.50 grams | 16.50 | 3.50 | 4.02 | 2 | Self-extinguished | 2 |
| | (dried) | | | | | | |
| 10 | 17 grams | 17 | 3 | 3.45 | 2 | Self-extinguished | 1.50 |
| | (dried) | | | | | | |
| 11 | 18 grams | 18 | 2 | 2.30 | 2 | Self-extinguished | 1 |
| | (dried) | | | | | | |
| 12 | 17.5 grams | 17.50 | 2.50 | 2.50 | 2 | Did not ignite | 0 |
| | (dried) | | | | | | |
| 13 | 74 grams | 74 | 14 | 16.09 | 12 | Did not ignite | 0 |
| | (undried) | | | | | | |

Among the various compositions of sealant containing resin from Canarium ovatum tree that are tested, four are found to exhibit properties that satisfy the flammability test of aviation laws regulations, particularly the 14 Code of Federal Regulation Appendix N to Part 25—Fuel Tank Flammability Exposure and Reliability Analysis. These four compositions, hereinafter referred to as Experimental Sealant Samples 1 to 4 respectively, are summarized in Table 4. In this table “wt” stands for “weight”. Their other important properties are presented in Tables 3 to 10 and are subsequently discussed further.

TABLE 4
Composition of the sealant.

| Experimental Sealant | | | | | Base Material |
|---|---|---|---|---|---|
| | | | | Manganese | Weight ratio |
| | Resin | | Toluene | dioxide | of resin to |
| Sample | Preparation | wt % | wt % | wt % | toluene |
| 1 (Compo- | Undried | 81.8 | 9.1 | 9.1 | 9.00 |
| sition 5) | | | | | |
| 2 (Compo- | Undried | 84.1 | 6.8 | 9.1 | 12.37 |
| sition 6) | | | | | |
| 3 (Compo- | Dried | 79.5 | 11.4 | 9.1 | 7.00 |
| sition 12) | | | | | |
| 4 (Compo- | Undried | 74.0 | 14.0 | 12.0 | 5.29 |
| sition 13) | | | | | |

### Example 3: Physical Descriptions of Sample Formulations of the [Flame Retardant Composition/Sealant]

Physical descriptions of the sample formulations of the [flame retardant composition/sealant] and a commercial sealant are found in Table 5.

An essential advantage in the physical property of the sample formulations over the commercial sealant is the odor. The formulated sealants are found to be more pleasant than the commercial sealant, which may be explained by the fact that pili tree resin is an oleoresin type that contains essential oils that have been used as a perfume component.

The results also show sealant samples to be black while the commercial sealant is brownish-black.

According to L*a*b* color measurement both experimental and commercial sealant displayed lower luminosity (L*) with a green value of (a*) color chromaticity layer.

With regards to (b*) color chromaticity layer, Sample 3 and commercial sealant show a yellow value while the three remaining sealant formulations obtained exhibit a blue value.

TABLE 5
Comparison of organoleptic properties and appearance of the
formulated sealant and Naftoseal ® MC-238.

| Experimental Sealant | | | | Naftoseal |
|---|---|---|---|---|
| 1 | 2 | 3 | 4 | MC-238 |

Organoleptic Properties

| | | | | | |
|---|---|---|---|---|---|
| Color | Black | Black | Black | Black | Brownish black |
| Odor | Solvent- | Mint- | Mint- | Varnish- | Similar to |
| | like | like | like | like | odor of burnt |
| | | | | | rubber |
| Appearance | Semi- | Matte, | Matte, | Glossy, | Glossy, |
| | glossy, | Rough | Rough | slightly | smooth |
| | rough | surface | surface | rough | surface |
| | surface | | | surface | |

Instrumental Color Measurement Test

| | | | | | |
|---|---|---|---|---|---|
| L* (lightness) | −6.98 | −6.42 | −7.64 | −4.53 | −0.74 |
| a* (red/green) | −1.15 | −0.88 | −1.40 | −0.20 | −0.23 |
| b* | −0.10 | −0.49 | 0.17 | −0.82 | 0.06 |
| (blue/yellow) | | | | | |
| Color | 4.35 | 3.97 | 4.84 | 2.88 | 0.54 |
| difference* | | | | | |

### Example 4: Physico-Chemical Properties of Sample Formulations of the [Flame Retardant Composition/Sealant]

Table 6 shows physico-chemical three chemical properties of samples of the formulated sealant and Naftoseal® MC-238. Tack free time is the time at which the sealant is deemed to be correctly adhered to a surface without being disrupted or damaged. Curing time is the time when the chemical reaction that hardens the sealant is complete, and its mechanical strength is maximal. Short tack and curing time are desired. Durometer hardness of a sealant refers to its hardness and ability to resist indentation. Lower numbers indicate less resistance and softer materials. In Table 6, the values of the chemical properties that are better than the corresponding properties of Naftoseal® are shaded. As seen in this table, the Durometer hardness of all compositions of the formulated sealant exceeds the hardness of the commercially available sealant Naftoseal® MC-238. In terms of tack free time and curing time, however, Samples 2 and 4 are better than the commercial sealant. Thus, Samples 2 and 4 are readily seen as superior to Naftoseal® in tack-free time, curing time, and durometer hardness.

On the other hand, the flashpoint test is performed to exhibit the quantitative aspect of the physical property of both experimental and commercial sealant formulations since this is one of the critical tests for this material property. Results obtained show that Sample 1 and 2 have the highest flashpoint among the five sealants and according to MSDS, materials having a higher flash point are less flammable and hazardous. Furthermore, these two experimental sealant samples exceeded the data result of the commercial sealant in the Flash Point Test.

TABLE 6
Comparison of physico-chemical properties of the formulated
sealant and Naftoseal ® MC -238

| Physico-chemical | Experimental Sealant | | | | Naftoseal ® |
|---|---|---|---|---|---|
| Property | 1 | 2 | 3 | 4 | MC-238 |
| Tack Free Time | 8 + 20 | 6 + 35 | 11 + 50 | 5 + 30 | 7 + 40 |
| (hrs + min) | | | | | |
| Curing Time | 9 + 45 | 7 + 50 | 13 + 45 | 7 + 10 | 8 + 30 |
| (hrs + min) | | | | | |
| Flash Point (° C.) | 46 | 48 | 34 | 28 | 38 |
| Durometer Hardness | 52.81 | 53.04 | 58.40 | 57.52 | 48.56 |

### Example 5: Mechanical Properties of Sample Formulations of the [Flame Retardant Composition/Sealant]

Table 7 compares four mechanical properties of samples of the sealant and Naftoseal® MC-238. The tensile strength is the breaking strength of a specimen under the exertion of a force capable of breaking many threads simultaneously, at a constant rate of 95 extension/load. Tear strength is the maximum force required to tear a test specimen in a direction normal to (perpendicular to) the direction of the stress. Shear strength is a measure of the maximum shear stress that may be sustained before a material rupture. Finally, peel strength is used to measure the bond strength of the material.

Shown in Table 7 are the peel strength values produced test panel length varying from 12.77 mm to 127 mm.

In Table 7, the shading highlights properties of the experimental sealant that exceed the corresponding properties of Naftoseal® MC-238. The tensile strengths of all samples of the formulated sealant are higher in comparison with the same property of the commercial sealant. Except for Sample 1, all other samples of the experimental sealant exhibit higher tear strength than the commercial sealant. The difference is more pronounced in the case of Samples 2 and 4. In addition, all but Sample 3 of the formulated sealant show higher shear strength. Finally, with respect to peel strength, Samples 1 and 2 appear to be superior to Naftoseal® MC-238.

TABLE 7
Comparison of mechanical properties of the formulated
sealant and Naftoseal ® MC-238

| | Experimental Sealant | | | | Naftoseal ® |
|---|---|---|---|---|---|
| Mechanical Property | 1 | 2 | 3 | 4 | MC-238 |
| Tensile Strength | 2.0900 | 2.3560 | 1.9220 | 2.3320 | 1.6680 |
| (MPa) | | | | | |
| Tear Strength | 20.608 | 27.864 | 22.076 | 27.954 | 21.706 |
| (MPa) | | | | | |
| Shear Strength | 0.1071 | 0.0924 | 0.0018 | 0.0026 | 0.0019 |
| (kg_{f}/mm²) | | | | | |
| Peel Strength | | | | | |
| (kg_{f}/mm²) | | | | | |
| at 12.70 mm | 0.3600 | 0.4079 | 0.0998 | 0.0988 | 0.1057 |
| at 25.40 mm | 0.3797 | 0.4268 | 0.0638 | 0.0768 | 0.0802 |
| at 38.10 mm | 0.3778 | 0.3956 | 0.0699 | 0.0789 | 0.0845 |
| at 0.80 mm | 0.4264 | 0.4233 | 0.0785 | 0.0870 | 0.0935 |
| at 63.50 mm | 0.4272 | 0.3964 | 0.0789 | 0.0927 | 0.0971 |
| at 76.20 mm | 0.4529 | 0.4302 | 0.0920 | 0.0988 | 0.1037 |
| at 88.90 mm | 0.4707 | 0.4756 | 0.0969 | 0.1134 | 0.1041 |
| at 101.60 mm | 0.4509 | 0.4748 | 0.1043 | 0.1183 | 0.1179 |
| at 114.30 mm | 0.5388 | 0.4864 | 0.1055 | 0.1163 | 0.1226 |
| at 127 mm | 0.4941 | 0.4744 | 0.1117 | 0.1252 | 0.1285 |

### Example 6. Knife Test and Pull-Off Strength Ratings of Sample Formulations of the [Flame Retardant Composition/Sealant]

Table 8 displays the Knife test ratings and pull-off strength of the sealant and Naftoseal® MC-238. Knife test is used to determine the adhesion of organic coatings when applied to smooth and flat panel surfaces using a cutting knife.

Pull-off strength measures the resistance of a sealant to separation from a substrate when a perpendicular tensile force is applied.

In the tests conducted to compare the mechanical strengths in Table 8, the substrate used is aluminum.

In knife tests, Samples 3 and 4 rate higher than Naftoseal® MC-238, as can be seen in Table 8. On the other hand, only Sample 4 consistently shows higher pull-off strength relative to Naftoseal® MC-238 as time passed. Twenty-one and more days after curing, Samples 1 and 2 exhibit higher pull-off strength.

TABLE 8
Comparison of mechanical properties of the formulated
sealant and Naftoseal ® MC-238

| | | |
|---|---|---|
| Mechanical | Experimental Sealant | Naftoseal ® |

| | | | | | |
|---|---|---|---|---|---|
| Property | 1 | 2 | 3 | 4 | MC-238 |

Knife Test Rating (applied days after wet curing)

| | | | | | |
|---|---|---|---|---|---|
| 7 days | 6 | 4 | 8 | 8 | 8 |
| 14 days | 6 | 6 | 8 | 10 | 8 |
| 21 days | 8 | 6 | 10 | 10 | 10 |
| 28 days | 10 | 8 | 10 | 10 | 10 |
| 35 days | 10 | 8 | 10 | 10 | 8 |

Pulloff Strength (lb_{f}/in²) (applied days after wet curing)

| | | | | | |
|---|---|---|---|---|---|
| 7 days | 780 | 480 | 650 | 710 | 630 |
| 14 days | 730 | 600 | 510 | 840 | 750 |
| 21 days | 730 | 730 | 660 | 820 | 700 |
| 28 days | 890 | 950 | 680 | 780 | 780 |
| 35 days | 890 | 1010 | 800 | 790 | 740 |

### Example 7: Thermal Properties Measurement of Sample Formulations of the [Flame Retardant Composition/Sealant]

Table 9 compares the results of three key thermal property tests on the experimental sealant and Naftoseal® MC-238: thermogravimetry-differential thermal analysis, differential scanning calorimetry, and measurement of calorific value. These tests show how temperature affects the stability of both experimental and commercial sealants.

TABLE 9
Comparison of thermal properties of the formulated sealant and Naftoseal ® MC-238

| Thermal | Experimental Sealant | | | | Naftoseal ® |
|---|---|---|---|---|---|
| Property | 1 | 2 | 3 | 4 | MC-238 |

Thermogravimetry-Differential Thermal Analysis Test

| | | | | | |
|---|---|---|---|---|---|
| % Weight Loss | WL1 = 13.631 | WL1 = 14.883 | WL1 = 12.947 | WL1 = 14.647 | WL1 = 69.542 |
| | WL2 = 13.203 | WL2 = 12.106 | WL2 = 10.683 | WL2 = 60.781 | WL2 = 14.935 |
| | WL3 = 51.103 | WL3 = 50.415 | WL3 = 52.933 | WL3 = 8.279 | |
| | WL4 = 6.006 | WL4 = 4.991 | WL4 = 6.392 | WL4 = 5.197 | |
| | WL5 = 3.089 | WL5 = 3.123 | WL5 = 5.949 | | |
| Peak | Tₚ₁ = 104.16 | Tₚ₁ = 102.61 | Tₚ₁ = 99.69 | Tₚ₁ = 139.31 | Tₚ₁ = 284.87 |
| temperature | Tₚ₂ = 198.76 | Tₚ₂ = 195.98 | Tₚ₂ = 166.49 | Tₚ₂ = 359.45 | Tₚ₂ = 739.73 |
| (° C.) | Tₚ₃ = 366.44 | Tₚ₃ = 362.35 | Tₚ₃ = 353.39 | Tₚ₃ = 441.46 | |
| | Tₚ₄ = 437.92 | Tₚ₄ = 441.46 | Tₚ₄ = 432.72 | | |
| Temperature | 30.95-154.07 | 30.91-155.89 | 30.00-152.25 | 30.49-224.82 | 30.87-430.01 |
| range (° C.) | 154.07-248.18 | 155.89-239.19 | 152.25-231.12 | 224.82-404.38 | 430.01-943.15 |
| | 248.18-406.54 | 239.19-409.39 | 231.12-398.71 | 404.38-473.55 | |
| | 406.54-473.16 | 409.39-478.67 | 398.71-480.87 | | |
| Peak | Tₚ₁ = 104.70 | Tₚ₁ = 103.65 | Tₚ₁ = 100.39 | Tₚ₁ = 374.10 | Tₚ₁ = 283.21 |
| temperature | (endo) | (endo) | (endo) | (endo) | (endo) |
| (° C.) | Tₚ₂ = 363.52 | Tₚ₂ = 363.35 | Tₚ₂ = 360.86 | | |
| | (endo) | (endo) | (endo) | | |

Differential Scanning Calorimetry

| | | | | | |
|---|---|---|---|---|---|
| Melting Point | 123.41 | 126.41 | 126.42 | 117.44 | 119.46 |
| (° C.) | | | | | |
| Enthalpy (ΔH) | ΔH₁ = 13.2160 | ΔH₁ = 19.8697 | ΔH₁ = 12.3493 | ΔH₁ = 22.8147 | ΔH₁ = 2.4596 |
| (J/kg) | ΔH₂ = 5.5904 | ΔH₂ = 3.9246 | ΔH₂ = 0.06970 | ΔH₂ = 5.0866 | ΔH₂ = 163.4232 |
| | ΔH₃ = 60.0118 | ΔH₃ = 70.1789 | ΔH₃ = 1.0366 | ΔH₃ = 35.9769 | |
| | | | ΔH₄ = 38.3488 | | |

Calorific Value

| | | | | | |
|---|---|---|---|---|---|
| Calorific value | 13,589 | 14,636 | 14,246 | 14,145 | 8,005 |
| (BTU/lb) | | | | | |

According to thermogravimetric-differential thermal analysis, all sealant samples displayed better thermal stability by showing no drastic weight loss during the whole duration of the temperature programmed from 30° C. to 950° C. Likewise, the peak temperature of all sealant samples exhibits a high-temperature resistance ranging from 359° C. to 366° C. with an endothermic reaction before reaching their highest amount of weight loss.

On the other hand, the commercial sealant exhibits the highest percentage of weight loss, specifically in its first peak of about 69.542% at a peak temperature of 284° C. Furthermore, it can also be seen in Table 9 that the commercial sealant showed thermal instability as indicated by its significant weight degradation, which is noticeable in its first peak temperature.

Concerning differential scanning calorimetry test, three experimental sealant samples (Samples 1, 2, and 3) exhibited a high resistance temperature ranging from 123° C. to 126° C. before it melted compared to the commercial sealant having a melting point of 119.46° C.

Furthermore, compared to commercial sealant, the three samples, together with Sample 4, obtain a higher value of gross heat based on the Calorific Value Test, demonstrating high temperature and heat resistance before total combustion occurred.

Therefore, all the data from the thermal property tests reveal that the formulated sealant per the present invention is better than Naftoseal® MC-238 in terms of thermal stability and resistance. Regarding these thermal properties, the compositions may be used as flame retardants.

### Example 8: Rheological Properties of Sample Formulations of the [Flame Retardant Composition/Sealant]

TABLE 10
Comparison of rheological properties of the formulated
sealant Naftoseal ® MC-238

| Rheolo- | | | | | |
|---|---|---|---|---|---|
| gical | Experimental Sealant | | | | Naftoseal ® |
| Property | 1 | 2 | 3 | 4 | MC-238 |
| Viscosity | 177.2180 | 154.0150 | 190.5300 | 147.3470 | 175.50 |
| (Pa-sec) | | | | | |

The rheological properties of experimental and commercial sealants are detailed in the table above. Given the result, two experimental sealant samples namely Sample 1 and 3, surpass the viscosity value of the commercial sealant. With this characteristic, the two mentioned sealant samples displayed non-drip or non-sagging properties. They can be used in applications where the sealant needs to stay in its place while applying and curing. Thus, the viscosity results of Sample 1 and 3 prove that the rheological property of the experimental sealant sample type is more efficient and effective compared to the commercial sealant.

### Example 9: Toxicity Parameters of Formulations of the Sealant [Flame Retardant Composition/Sealant]

Table 11 compares the toxicity parameters of the experimental sealant samples and Naftoseal® MC-238. The meanings of the toxicity statements in this table are shown in Table 12. The latter table shows first that there are three toxicity levels: harmful (H302 and combinations thereof with other statements), toxic (H301, H311, H331 and combinations thereof with other statements), and fatal (H300, H310, H330, and combinations with other statements). Examination of Table 11 reveals that Naftoseal® MC-238 can have fatal effects if swallowed, comes into contact with the skin, or inhaled as a vapor. On the other hand, the four (4) samples of the sealant formulations are only classified as “harmful” or “toxic”. Moreover, the toxicity of the experimental sealant expressed as “toxic concentration” and defined as the minimum concentration at which a particular substance produces a toxic effect, occurs at far higher concentrations than that of Naftoseal® MC-238. In sum, therefore, the toxicity of the samples is much less than that of the commercial sealant.

Among the sealant samples, Sample 4 has the lowest rating in terms of toxicity, described only as “harmful” as far as oral and dermal toxicity is concerned and only as “toxic” in its vapor form. In addition, its toxic concentration is nearly 25 times that of Naftoseal® MC-238. The following best sample insofar as Table 11 is Sample 1, whose toxic concentration is 12 times that of Naftoseal® MC238 or nearly half that of Sample 2. Finally, Samples 2 and 3 are only slightly different from each other and only 5 to 6 times less toxic than Naftoseal® MC-238.

It will thus be seen that the samples set forth above can be seen as embodiments of the sealant composition. Sample 4 is one embodiment, while Sample 1 is preferred because of its superior peel strength and melting point. The most preferred embodiment having the most desirable properties is Sample 2. These embodiments compare well with Naftoseal® MC-238 as far as physico-chemical, mechanical, and thermal properties relevant to the functions of sealants and have the additional advantage of being less toxic than Naftoseal® MC-238.

TABLE 11
Comparison of toxicity of the formulated sealant and Naftoseal ® MC-238

| Toxicity Parameter | Experimental Sealant | | | | Naftoseal ® |
|---|---|---|---|---|---|
| or Description | 1 | 2 | 3 | 4 | MC-238 |
| Toxic | 514.0 | 217.8 | 281.6 | 1006 | 41.9 |
| Concentration | | | | | |
| (ppm) | | | | | |
| Oral Toxicity | IV | III | III | IV | II |
| Category | | | | | |
| Oral Toxicity | H302 | H301, | H301, | H302, | H300, |
| Statements | | H301 + H311 | H301 + H311 | H302 + H312 | H300 + H310, |
| in MSDS | | | | | H300 + H330, |
| | | | | | H300 + H310 + |
| | | | | | H330 |
| Description | Warning | Danger | Danger | Warning | Danger |
| Dermal Toxicity | III | II | II | III | I |
| Category | | | | | |
| Dermal Toxicity | H311, | H311, | H311, | H302, | H310, |
| Statements | H311 + H331 | H311 + H331 | H311 + H331 | H302 + H312 | H300 + 3310, |
| in MSDS | | | | | H310 + 3330, |
| | | | | | H300 + H310 + |
| | | | | | H330 |
| Description | Danger | Danger | Danger | Warning | Danger |
| Gases (Category) | III | II | II | III | I |
| Toxicity | H331 | H330 | H330 | H331 | H330, |
| Statements | | | | | H300 + H330, |
| in MSDS | | | | | H310 + 3330, |
| | | | | | H300 + H310 + |
| | | | | | H330 |
| Description | Danger | Danger | Danger | Danger | Danger |

In addition to this, these embodiments point to a further application of the compositions, namely, in retarding flames. For this application, Sample 3 is one embodiment, while Sample 1 and 2 are preferred because they surpassed the flash point and flammability result of the commercially available aviation sealant.

In pointing out these embodiments of the invention, it is not the intent to limit the invention to these specific examples. Instead, the aim is to illustrate the general spirit and scope of the invention. In reproducing the compositions and methods described herein, certain changes may occur, but the results should not be interpreted as departing from such spirit and scope.

TABLE 12
Meaning of MSDS Statements

| | Meaning |
|---|---|
| H300 | Fatal if swallowed |
| H301 | Toxic if swallowed |
| H302 | Harmful if swallowed |
| H300 + H310 | Fatal if swallowed or in contact with skin |
| H300 + H330 | Fatal if swallowed or if inhaled |
| H300 + H310 + H330 | Fatal if swallowed, in contact with |
| | skin or if inhaled |
| H301 + H311 | Toxic if swallowed or in contact with skin |
| H302 + H312 | Harmful if swallowed or in contact with skin |
| H310 | Fatal in contact with skin |
| H311 | Toxic in contact with skin |
| H311 + H331 | Toxic in contact with skin or if inhaled |
| H310 + H330 | Fatal if in contact with skin or if inhaled |
| H300 + H310 + H330 | Fatal if swallowed, in contact with |
| | skin or if inhaled |
| H330 | Fatal if inhaled |
| H331 | Toxic if inhaled |

The preferred embodiments of this invention are described in the above-mentioned detailed description. It is understood that those skilled in the art may conceive modifications and/or variations to the embodiment shown and described therein. Any such modifications or variations that fall within the purview of this description are intended to be included therein as well. Unless specifically noted, it is the intention of the inventor that the words and phrases in the specification and claims be given the ordinary and accustomed meanings to those of ordinary skill in the applicable art. The foregoing description of a preferred embodiment and best mode of the invention known to the applicant at the time of filing the application has been presented and is intended for the purposes of illustration and description. It is not intended to be exhaustive or to limit the present invention to the precise form disclosed, and many modifications and variations are possible in the light of the above teachings.

1. A composition exhibiting flame retardant properties comprising:
Canarium ovatum tree resin and a solvent;

2. The composition according to claim 1, wherein the Canarium ovatum tree resin is at 74 to 92.5% by weight.

3. The composition according to claim 1, wherein the solvent is at 6.8 to 26% by weight.

4. The composition according to claim 1, wherein the Canarium ovatum tree resin is either dried or undried Canarium ovatum tree resin.

5. The composition according to claim 1, wherein the solvent is an organic solvent.

6. A sealant comprising:
a base material, wherein the base material further comprising:
Canarium ovatum tree resin and a solvent; and
an activator.

7. The sealant according to claim 6, wherein the sealant comprises the base material at 88.0 to 90.9% by weight.

8. The sealant according to claim 6, wherein the activator at 9.1 to 12.0% by weight.

9. The sealant according to claim 6, wherein the activator is a metal oxide.

10. The sealant of claim 6, wherein the weight ratio of the Canarium ovatum tree resin to the solvent of the base material ranges from 5.29 to 12.33.

11. A method for making a Canarium ovatum tree resin sealant, comprising the steps of:
a. extracting Canarium ovatum tree resin from Canarium ovatum tree bark;
b. adding a solvent to the extracted Canarium ovatum tree resin to make a base material for the Canarium ovatum tree sealant;
c. homogenizing the base material; and
d. adding an activator to the homogenized base material to produce the Canarium ovatum tree resin sealant.
